(19) United States
(12) Patent Application Publication
(10) Pub. No.: US 2026/0063095 A1
(43) Pub. Date: Mar. 5, 2026

(54) DUAL FUEL ENGINE SYSTEM, AN INTAKE MANIFOLD, AND A METHOD OF MANUFACTURING A DUAL FUEL ENGINE SYSTEM

(71) Applicant: Cummins Inc., Columbus, IN (US)

(72) Inventors: Simon Anthony Burge, Rugby (GB); Vincent Denoyelle, Daventry (GB); Jacob Harris, Northamptonshire (GB); Saurabh Gupta, Indianapolis, IN (US); Bryce Tiller, Columbus, IN (US); Ian Fall, East Hunsbury (GB); Anthony A. Lewis, Daventry (GB); Axel O. zur Loye, Battle Ground, WA (US); Marten H. Dane, Columbus, IN (US); Jonathan W. Georgas, Minneapolis, MN (US)

(73) Assignee: Cummins Inc., Columbus, IN (US)

(21) Appl. No.: 19/315,277

(22) Filed: Aug. 29, 2025

(30) Foreign Application Priority Data
Aug. 30, 2024 (GB) 2412759.9

(51) Int. Cl. F02M 35/10; F02M 35/104; F02M 43/04; F02M 55/00; F02M 55/02; F02M 61/14

(52) U.S. Cl. CPC F02M 35/10216; F02M 35/104; F02M 43/04; F02M 55/004; F02M 55/025; F02M 61/145; F02M 2200/855; F02M 2200/858

(57) ABSTRACT

A dual fuel engine system and/or retrofit system includes a cylinder head, an intake manifold, a first fuel injector, and a second fuel injector. The cylinder head defines an intake port. The intake manifold is coupled to the cylinder head. The first fuel injector extends into the cylinder head and is configured to dispense a first fuel. The second fuel injector extends through the intake manifold and into the cylinder head. The second fuel injector is configured to dispense a second fuel. The second fuel injector is oriented to spray the second fuel into the intake port.

### BACKGROUND

This application claims the benefit of and priority to U.K. Patent Application No. 2412759.9, filed Aug. 30, 2024, the entire contents of which are hereby incorporated by reference herein.

### TECHNICAL FIELD

The present disclosure relates generally to the field of dual fuel engine systems, and fuel systems for dual fuel engine systems.

### BACKGROUND

Dual fuel engine systems are designed to operate using a combination of fuels, which can include gaseous or liquid fuels. Existing dual fuel engine systems are designed to utilize a primary fuel, often diesel or gasoline, and a secondary fuel, such as methanol, ethanol (e.g., an alcohol-based fuel), or another type of liquid or gaseous fuel. These engine systems can operate using the primary fuel alone or in a dual fuel mode using both the primary fuel and the secondary fuel in the compression ignition engine. In some dual fuel engine systems, a significant fraction of the fuel energy can be supplied by the second fuel. The use of the secondary fuel can lower the carbon intensity of fuel consumed and the carbon footprint generated by the engine system during operation. The use of the secondary fuel can also reduce operational costs as compared to operating using the primary fuel alone.

### SUMMARY

One aspect of the present disclosure relates to a dual fuel engine system including a cylinder head, an intake manifold, a first fuel injector, and a second fuel injector. The cylinder head defines an intake port. The intake manifold is coupled to the cylinder head. The first fuel injector extends into the cylinder head and is configured to dispense a first fuel. The second fuel injector extends through the intake manifold and into the cylinder head. The second fuel injector is configured to dispense a second fuel. The second fuel injector is oriented to spray the second fuel into the intake port.

Another aspect of the present disclosure relates to an intake manifold including a manifold body and an injector mount. The manifold body defines an airflow plenum therethrough. The injector mount extends at least partially through the airflow plenum. The injector mount defines a bore extending through opposing ends of the manifold body. The bore is sized to receive a fuel injector therein. The injector mount includes a tube that fluidly separates the bore from the airflow plenum along an entire axial length of the bore.

Yet another aspect of the present disclosure relates to a method of manufacturing a dual fuel engine system. The method includes coupling an intake manifold to a cylinder head of the dual fuel engine system that includes a first fuel injector extending into the cylinder head. The first fuel injector is configured to dispense a first fuel. The method also includes inserting a second fuel injector through the intake manifold and into the cylinder head so that the second fuel injector is oriented to spray a second fuel into an intake port that is defined by the cylinder head.

This summary is illustrative only and should not be regarded as limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a dual fuel engine system showing an intake manifold of the dual fuel engine system, according to an embodiment.

FIG. 2 is a front side cross-sectional view of the dual fuel engine system of FIG. 1, taken through a secondary fuel injector of the dual fuel engine system.

FIG. 3 is a top side cross-sectional view of the dual fuel engine system of FIG. 1, taken through the secondary fuel injector.

FIG. 4 is another perspective view of the dual fuel engine system and intake manifold of FIG. 1.

FIG. 5 is a perspective view of another intake manifold for use with a dual fuel engine system, according to an embodiment.

FIG. 6 is a top side cross-sectional view of the dual fuel engine system of FIG. 1, taken through the secondary fuel injector.

FIG. 7 is a reproduction of FIG. 6 that shows the sealing interfaces between (i) the secondary fuel injector and (ii) the intake manifold and a cylinder head of the dual fuel engine system.

FIG. 8 is a perspective view of the secondary fuel injector of FIG. 1.

FIG. 9 is a perspective view of a rotational support element for the dual fuel engine system of FIG. 1.

FIG. 10 is a flow diagram of a method of manufacturing a dual fuel engine system and/or retrofitting a compression ignition engine system to utilize multiple fuels, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are contemplated and made part of this disclosure.

Embodiments of the present disclosure relate to systems and methods for retrofitting a single-fuel compression ignition or spark ignition engine system (e.g., an existing engine system that is configured for use with a single fuel (e.g., diesel fuel, etc.)) to use multiple fuels or to inject fuel using a port injection arrangement, while reducing the number of new components and in-use parts on the compression ignition engine system that need to be modified or replaced. The system includes an intake manifold that is designed to receive and support a second fuel injector for a secondary fuel therein. The intake manifold is designed to support the second fuel injector in position within the cylinder head and so that the second fuel is directed toward the intake port of the cylinder head. Beneficially, such an arrangement can enable access of the second fuel injectors from outside of the engine system, which can enable maintenance/servicing of the second fuel injectors without significant removal of additional engine system hardware (e.g., turbochargers, intake manifolds, exhaust manifolds, and/or other engine equipment/accessories, etc.). Such an arrangement also enables integration of the second fuel injector near the cylinder without having to significantly redesign the cylinder head.

Although the description below refers to compression ignition engine system arrangements, it should be understood that the same or a similar design for the retrofit system 200 may be used on other types of engine systems, including: 1) to provide port injection (e.g., a port fuel injection) arrangement on a spark ignition engine system; 2) to provide a port injection arrangement on an engine system that only uses a single fuel; 3) to provide dual fuel injection for an engine system that uses two fuels; 4) an engine system that uses only port injectors to deliver fuel to the engine; and 5) an engine system that has both port injectors (e.g., port fuel injectors) and a second (potentially primary) fuel system. This second fuel system can be a direct fuel injection system, an upstream mixed fuel injection system (e.g., a fuel mixer upstream of a compressor), or a fuel system that is located between a compressor inlet of a compressor and a port fuel injector.

In some embodiments, the second fuel injector is arranged so that the secondary fuel is sprayed toward a back side of an intake valve head of the compression ignition engine system. In at least one embodiment, the second fuel injector is an offset fuel injector having an asymmetric spray plume that emanates from only a single side (e.g., a perimeter portion, etc.) of the fuel injector. In such embodiments, the second fuel injector is rotationally aligned with respect to the intake manifold and the cylinder head to direct the second fuel toward the back side of the intake valve head only. Beneficially, such an arrangement can reduce the risk of fuel accumulation within the cylinder head. Such an arrangement can also reduce impingement of fuel against the inner surfaces of the cylinder head and the intake tract of the cylinder head (i.e., wall-wetting), which can negatively affect the transient performance and emissions associated with injection of a fuel outside of the cylinder.

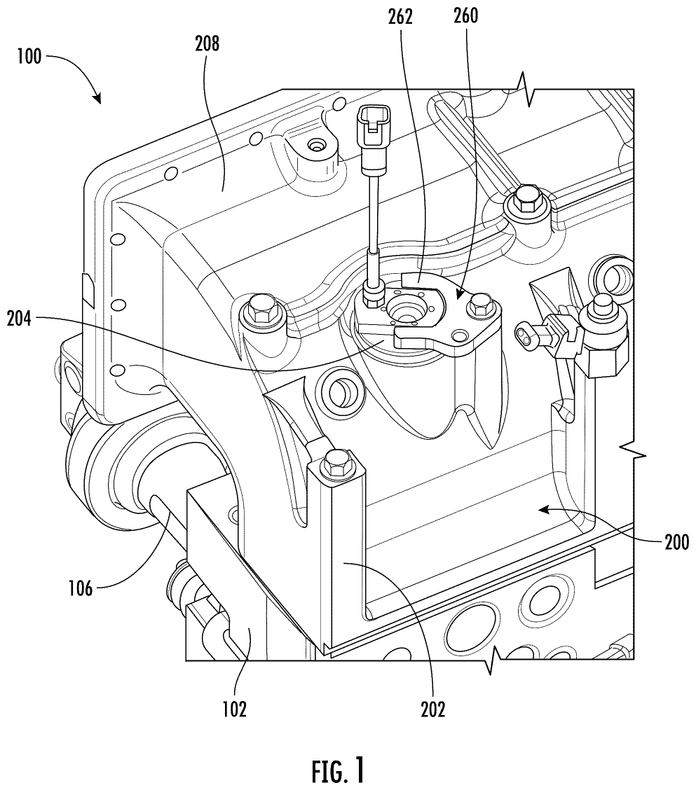

Referring to FIGS. 1-3, a dual fuel engine system 100 is shown, according to an embodiment. The dual fuel engine system 100 includes a cylinder head 102 defining an intake port 104; an intake manifold 202 coupled to the cylinder head 102; a first fuel injector 106 extending into the cylinder head 102 and configured to dispense a first fuel 108; and a second fuel injector 204 extending through the intake manifold 202 and into the cylinder head 102. The second fuel injector 204 is configured to dispense a second fuel 110 that is different from the first fuel 108. In other embodiments, the second fuel injector 204 is configured to dispense a second fuel 110 that is the same as the first fuel. The second fuel injector 204 is oriented to spray the second fuel 110 into the intake port 104.

In some embodiments, the intake manifold 202 and the second fuel injector 204 together define part of a retrofit system 200 (e.g., an upfit system, second fuel injection system, etc.) that is configured to retrofit an existing single fuel compression ignition engine system to use multiple fuels (e.g., that is configured retrofit an existing single fuel compression ignition engine system to form the dual fuel engine system 100). In some embodiments, the single fuel compression ignition engine system is a direct-injection diesel engine that includes at least one first fuel injector 106 that is configured to spray fuel directly into a cylinder 112. In some embodiments, the retrofit system 200 also includes a fuel rail assembly 206 that is configured to supply the second fuel 110 to the second fuel injector 204, as will be further described.

In some embodiments, the components used for the retrofit system 200 (e.g., tubes, pipes, seals etc.) are formed from materials that are chemically compatible for use with the second fuel. These materials can also be compatible for use with the other fluids and gasses used in, or produced by, an internal combustion engine system (e.g., glycol, oils, diesel, etc.) and can be formed from materials that are capable of withstanding the operating temperature range for the internal combustion engine system and applications in which the internal combustion engine system is used.

The retrofit system 200 can also include a dual fuel control module, which can be an electronic control module or direct fuel control module. The dual fuel control module can be configured to communicate with an existing single-fuel compression ignition engine control module to control fueling provided by, and operation of, the second fuel injectors 204.

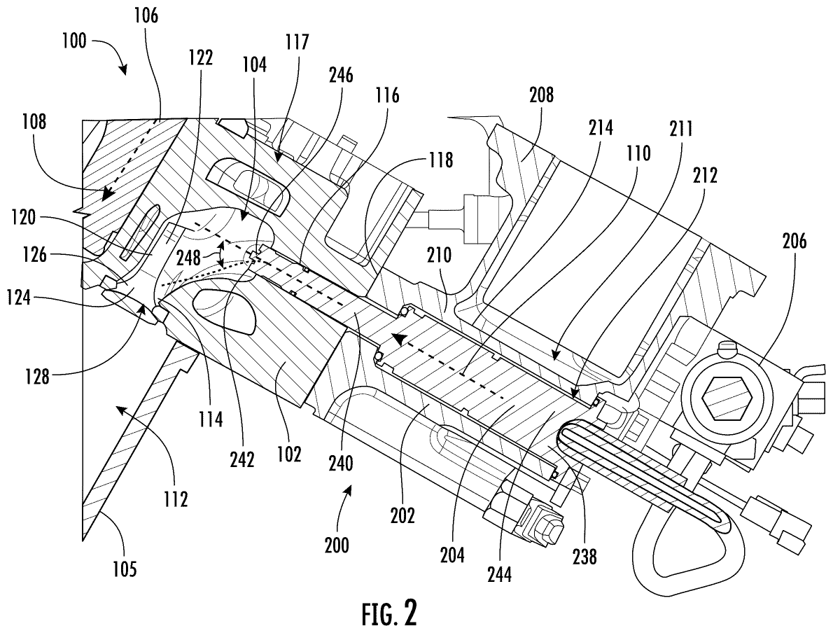

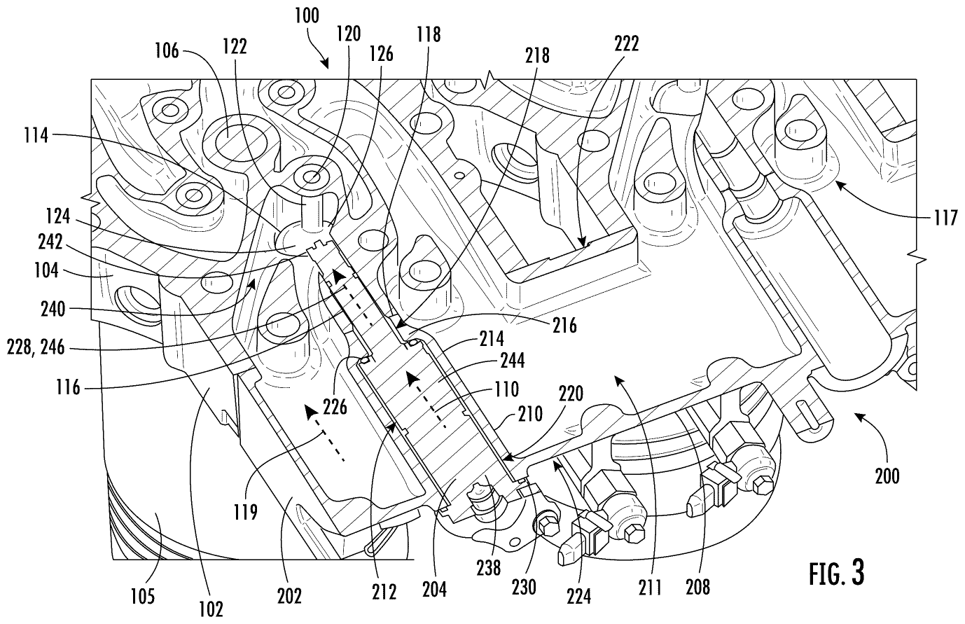

Referring to FIGS. 2-3, the dual fuel engine system 100 further includes an engine block 105 (e.g., a cylinder block, etc.) that is coupled to the cylinder head 102. The engine block 105 defines the cylinder 112.

The first fuel injector 106 extends through the cylinder head 102 and into the cylinder 112. In the embodiment of FIGS. 2-3, the first fuel injector 106 is a diesel fuel injector that is configured to inject the first fuel 108 (e.g., a primary fuel) directly into the cylinder 112.

The primary fuel can be diesel fuel or another type of liquid or gaseous fuel. The first fuel injector 106 can include a nozzle and a solenoid valve to control the flow of the first fuel 108 through the nozzle.

The cylinder head 102 is configured to direct a flow of air from the intake manifold 202 to a cylinder 112 of the dual fuel engine system 100. The cylinder head 102 is also configured to direct the flow of exhaust gases out of the cylinder 112. In the embodiment of FIG. 2-3, the cylinder head 102 defines at least one intake port 104, an intake opening 114, and an injector bore 116.

The at least one intake port 104 is configured to fluidly couple the intake manifold 202 (e.g., fluid passageways within the intake manifold 202) to the cylinder 112. The intake port 104 includes and intake channel 105 (e.g., an intake passageway, etc.) that is configured to direct air (e.g., charge air, etc.) through the cylinder head 102. The intake port 104 also include an intake opening 114 disposed at an end of the intake channel 105 away from the intake manifold 202. In some embodiments, the intake opening 114 defines an overall end of the intake port 104. In the embodiment of FIGS. 2-3, the cylinder head 102 defines a plurality of intake ports 104, each configured to supply air to a respective one of a plurality of cylinders 112.

The intake opening 114 is structured to fluidly couple the at least one intake channel 105 to the cylinder 112. In the embodiment of FIGS. 2-3, the intake opening 114 is disposed at an end (e.g., a distal end, an outlet end, etc.) of the intake channel 105 that is farthest away from the intake manifold and/or where the cylinder head 102 is coupled to the intake manifold 202. The intake opening 114 is disposed at an outlet end of the intake channel 105 farthest away from the intake manifold 202 along an air flow direction through the cylinder head 102. The intake opening 114 is sized to receive a portion of an intake valve 120 therethrough (e.g., a valve stem 122 of the intake valve 120). A valve head 124 of the intake valve 120 engages the cylinder head 102 at the intake opening 114.

The injector bore 116 is sized to receive a distal end (e.g., a tip portion that defines at least one nozzle 242) of the second fuel injector 204 therein and to guide the second fuel injector 204 toward a portion of the intake port 104 proximate to the intake opening 114. In the embodiment of FIGS. 2-3, the injector bore 116 is a cylindrical passageway that extends from an external surface 118 (e.g., an intake manifold interface surface) of the cylinder head and into the intake port 104. In some embodiments, the injector bore 116 is formed by machining (e.g., drilling) a passageway into an existing cylinder head 102. In other embodiments, the injector bore 116 is integrally formed with the cylinder head 102 during a casting operation.

In some embodiments, the injector bore 116 (e.g., a central axis of the injector bore 116) extends substantially parallel to an airflow direction 119 through the intake port 104. In other embodiments, the orientation of the injector bore 116 relative to the intake port 104 can be different.

In at least one embodiment, the cylinder head 102 is part of a cylinder head assembly 117 that further includes at least one intake valve 120 coupled to the cylinder head 102. The intake valve 120 is disposed at least partially within the cylinder head 102. The intake valve 120 covers the intake opening 114 and is configured to selectively introduce air from the intake port 104 to the cylinder 112.

The intake valve 120 includes a valve stem 122 and a valve head 124 coupled to an end of the valve stem 122. The valve head 124 is configured to engage the cylinder head 102 at the intake opening 114. The valve head 124 defines a rear surface 126 that faces toward the intake port 104. The valve head 124 also defines a forward surface 128 opposite the rear surface 126 that faces the cylinder 112.

In the embodiment of FIGS. 2-3, the injector bore 116 (e.g., a central axis of the injector bore 116) is oriented substantially perpendicular to the valve stem 122. In other embodiments, the relative orientation of the injector bore 116 and the valve stem 122 can be different.

The intake manifold 202 is configured to supply air to the cylinder head 102 (e.g., to the intake port 104. The intake manifold 202 is also configured to couple the second fuel injector 204 to the dual fuel engine system 100.

The intake manifold 202 includes a manifold body 208 defining an airflow plenum 211 therethrough. The intake manifold 202 also includes an injector mount 210 extending at least partially through the airflow plenum 211. The injector mount 210 defines a bore 212 extending through opposing ends of the manifold body 208. The bore 212 is sized to receive a fuel injector (e.g., the second fuel injector 204) therein. The injector mount 210 includes a tube 214 that fluidly separates the bore 212 from the airflow plenum 211 along an entire axial length of the bore 212.

The airflow plenum 211 is configured to direct air from a fresh air intake and/or intercooler of the dual fuel engine system 100 to the cylinder head 102. The airflow plenum 211 is an internal passageway or combination of internal passageways that extends through the manifold body 208. In some embodiments, the airflow plenum 211 includes multiple airflow passageways to distribute air uniformly between the intake ports 104 of the cylinder head 102.

The intake manifold 202 (e.g., the manifold body 208) includes an injector mount 210 extending therethrough. The injector mount 210 is configured to support the second fuel injector 204 in position on the manifold body 208. In the embodiment of FIGS. 2-3, the injector mount 210 includes a tube 214 that defines the bore 212. The bore 212 is a cylindrical bore having a substantially circular cross-section (e.g., a circular cross-section normal to a central axis thereof).

The injector mount 210 (e.g., the tube 214) separates the airflow plenum 211 of the intake manifold 202 from the second fuel injector 204 (e.g., from the bore 212). The tube 214 extends across an entire length of the intake manifold 202 and prevents air from bypassing the airflow plenum 211 and/or the cylinder head 102 through the bore 212.

Referring to FIG. 3, the tube 214 of the injector mount 210 includes a step 216 (e.g., a ledge, etc.) extending radially inwardly from an inner surface of the bore 212 proximate to an end 213 (e.g., a distal end, etc.) of the bore 212 (e.g., proximate to a manifold interface surface of the intake manifold 202 that is configured to engage the cylinder head 102).

In the embodiment of FIGS. 2-3, the step 216 defines a stepwise change in diameter of the bore 212 and divides the bore 212 between a first portion 218 (e.g., a first region, etc.) extending from a first external surface of the intake manifold 202 (e.g., the manifold interface surface), and a second portion 220 (e.g., a second region, etc.) that extends from the first portion 218 to a second external surface of the intake manifold 202 opposite from the first external surface. The first portion 218 of the bore 212 extends through a first end 222 of the manifold body 208. The second portion 220 of the bore 212 extends through a second end 224 of the manifold body 208 opposite the first end 222.

The step 216 separates the first portion 218 from the second portion 220. The first portion 218 has a reduced inner diameter relative to the second portion 220. The step 216 defines at least one sealing surface for the second fuel injector 204.

In at least one embodiment, the intake manifold 202 (e.g., the injector mount 210, the tube 214, the manifold body 208, etc.) defines multiple sealing surfaces for the second fuel injector 204 that are configured to engage with sealing members of the second fuel injector 204 to prevent loss of the second fuel 110 and/or leakage of charge air from the cylinder head 102. In the embodiment of FIG. 3, the step 216 defines a first axially facing sealing surface 226 of the injector mount 210. The first axially facing sealing surface 226 is a surface of the step 216 that is oriented substantially normal to the central axis 228 of the tube 214.

The injector mount 210 (e.g., the tube 214) further defines a second axially facing sealing surface 230 disposed along a perimeter of the bore 212. The second axially facing sealing surface 230 is spaced axially apart from the first axially facing sealing surface 226. In the embodiment of FIG. 3, the second axially facing sealing surface 230 is defined by a surface of the tube 214 at an overall axial end of the tube 214.

The second axially facing sealing surface 230 is oriented substantially parallel to the first axially facing sealing surface 226. Beneficially, the integration of axially facing sealing surfaces into the injector mount 210 can accommodate a greater range of dimensional tolerances for the injector bore 116, as will be further described.

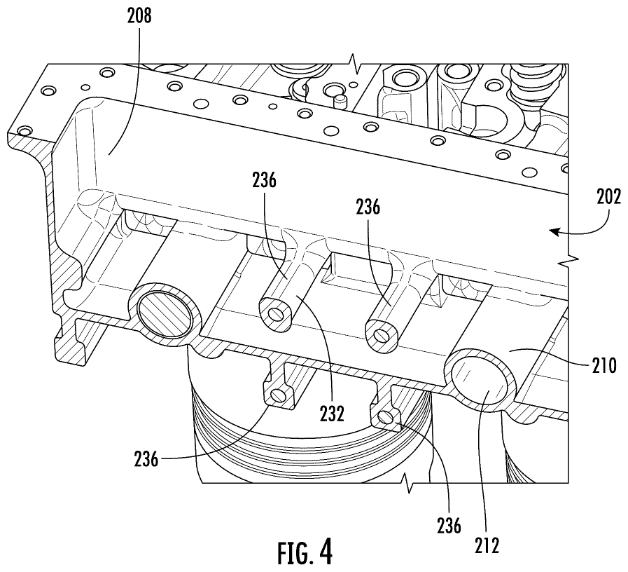

Referring to FIG. 4, the injector mount 210 can be integrally formed with the intake manifold 202 as a unitary body from a single piece of material. In such embodiments, the injector mount 210 can be at least partially formed during a casting process for the intake manifold 202. The bore 212 can also be formed during the casting process, and/or at least partially by a machining (e.g., drilling) operation after the casting operation is complete.

The manifold body 208 further defines a rail assembly mount 232 for supporting a fuel rail assembly 206 (e.g., an accumulator, etc.) (see also FIG. 2) on the manifold body 208. In some embodiments, the fuel rail assembly 206 is a common fuel rail configured to supply the second fuel 110 at elevated pressure to a plurality of second fuel injectors 204 (see FIG. 3).

In some embodiments, the fuel rail assembly 206 includes fuel lines and a fuel rail(s) that are double walled. In some embodiments, the doubled walled fuel lines and/or the fuel rail(s) include a nitrogen (or other inert gas) purge system to facilitate removal of fuel from the fuel lines and/or the fuel rail(s). In some embodiments, the fuel rail assembly 206 and/or another part of the retrofit system 200 includes a leak detection system that is configured to monitor conditions within the dual walled fuel lines and/or the fuel rail(s) and to detect leaks into the volume between the double wall structure.

In some embodiments, the dual fuel engine system 100 (e.g., the fuel rail assembly 206, the intake manifold 202, etc.) includes a purge and drain system for the second fuel. The purge and drain system is configured to reduce the volume of the second fuel trapped within the dual fuel engine system 100 (e.g., within the fuel rail assembly 206, the intake manifold 202, etc.). In some embodiments, the purge and drain system is a gravity-fed system that drains the second fuel from the engine system 100 under the force of gravity (e.g., after shutting down the engine system 100, etc.). In the embodiment of FIG. 4, the rail assembly mount 232 includes a plurality of mount elements 236 that extend parallel to the tube 214 of the injector mount 210. The mount elements 236 define mounting openings for the fuel rail assembly 206 to couple the fuel rail assembly 206 to the intake manifold 202. In the embodiment of FIG. 4, the rail assembly mount 232 is integrally formed with the intake manifold 202 as a unitary body from a single piece of material (e.g., by a casting operation).

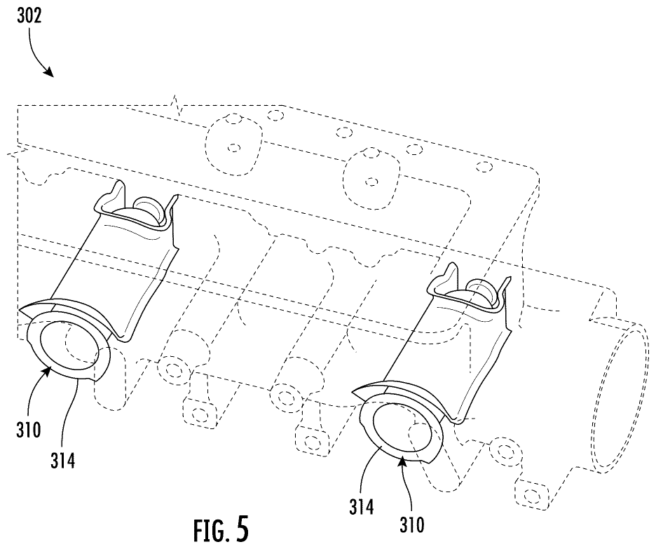

FIG. 5 depicts another embodiment of an intake manifold 302 for a dual fuel engine system. The intake manifold 302 includes a plurality of injector mounts 310 that are configured to couple a plurality of second fuel injectors to the intake manifold 302. Each injector mount 310 includes a tube 314 that is coupled to a lower wall of the intake manifold 302. The tubes 314 extend across the intake manifold 302. The position and arrangement of tubes 314 can be different in various embodiments.

Referring again to FIGS. 2-3, the second fuel injector 204 (e.g., alternative fuel injector, secondary fuel injector, liquid fuel injector, etc.) is configured to supply the second fuel 110 to the cylinder head 102. The second fuel injector 204 is one of a plurality of second fuel injectors that are each configured to supply the second fuel 110 to a respective cylinder of the cylinder head. The second fuel injector 204 includes an injector body 238 and a tip portion 240 including a nozzle 242. The injector body 238 includes an electronically controlled solenoid valve 244 that is configured to control actuation of the second fuel injector 204 and delivery of the second fuel 110 to the cylinder head 102. In some embodiments, the solenoid valve 244 is a pulse width modulated (PWM) valve that uses pulse width modulation to regulate the flow of the second fuel 110 to the cylinder head (e.g., to regulate a duty cycle and/or spray period, etc.).

In some embodiments, the second fuel 110 is a liquid fuel that is sprayed from the second fuel injector 204 into the cylinder head 102. The second fuel 110 can be an alcohol-based liquid fuel that includes at least one of ethanol or methanol. In other embodiments, the second fuel 110 can be diesel or natural gas, an e-fuel, or liquid biofuel. In yet other embodiments, the second fuel 110 can be any one of a high cetane number fuel, such as diesel, gas-to-liquid (GTL) diesel, heavy fuel oil (HFO), low sulfur fuel oil (LFSO), hydrotreated vegetable oil (HVO), marine gas oil (MGO), renewable diesel, biodiesel, paraffinic diesel, dimethyl ether (DME), F-76 fuel, F-34 fuel, jet A fuel, JP-4 fuel, JP-8 fuel, or oxymethylene ether (OME), or a low cetane number fuel (e.g., a high octane number fuel, a high methane number fuel). The low cetane number fuel can be natural gas, hydrogen, ethane, propane, butane, syngas, ammonia, methanol, ethanol, or gasoline. The fuel can optionally be a blend of fuels. It should be appreciated that the foregoing are merely examples of fuels, and other types of fuels are not precluded.

Referring still to FIGS. 2-3, the second fuel injector 204 is an offset fuel injector that is configured to dispense the second fuel 110 toward only a single side of the second fuel injector 204. As used herein, an offset fuel injector is a fuel injector that is structured to produce an asymmetric spray pattern viewed normal to the central axis 246 of the second fuel injector 204. The offset fuel injector is configured to spray fuel from a first perimeter portion of the fuel injector (e.g., a first perimeter portion of the nozzle 242) while blocking the flow of fuel from a second perimeter portion of the fuel injector. In such an arrangement, the spray of fuel is reduced to a single circumferential region relative to the fuel injector.

In the embodiment of FIGS. 2-3, the second fuel injector 204 is structured to spray the second fuel 110 from a single side of the tip portion 240. The second fuel injector 204 is oriented relative to the intake manifold 202 and the cylinder head 102 to spray the second fuel 110 toward the intake opening 114 of the cylinder head 102. In some embodiments, the second fuel injector 204 is oriented to spray the second fuel 110 along an air-flow direction through the cylinder head 102 during an intake event (e.g., while air is being pulled from the cylinder head 102 into the cylinder, etc.). In some embodiments, the second fuel injector 204 and/or the nozzle 242 are structured to spray the second fuel 110 toward a rear surface 126 of the valve head 124 so that a spray region of the spray does not extend radially beyond the rear surface 126 and/or the intake opening 114. Such an arrangement reduces the risk of fuel accumulation within the intake manifold 202, and reduces wall-wetting which occurs when some of the fuel is captured or remains along the walls of the cylinder head. Such an arrangement can improve transient performance (e.g., to reduce the time period required for the second fuel 110 to reach the cylinder upon actuation of the second fuel injector 204) and can also improve accuracy of fuel delivery to the cylinder by reducing the amount and risk of fuel sticking or otherwise being retained within the cylinder head after actuation of the second fuel injector 204.

In the embodiment of FIG. 2, a central axis 246 of the second fuel injector 204 is oriented substantially normal (e.g., perpendicular) to the valve stem 122 of the intake valve 120. The nozzle 242 of the second fuel injector 204 is arranged to direct the second fuel 110 at an angle 248 relative to the central axis 246 toward the intake opening 114. In the embodiment of FIG. 2, the angle 248 is approximately 45°relative to the central axis 246. In other embodiments, and depending on the orientation of the second fuel injector 204 and nozzle 242 with respect to the intake opening 114, the angle 248 can be different (e.g., approximately 30°, approximately 60°, etc.).

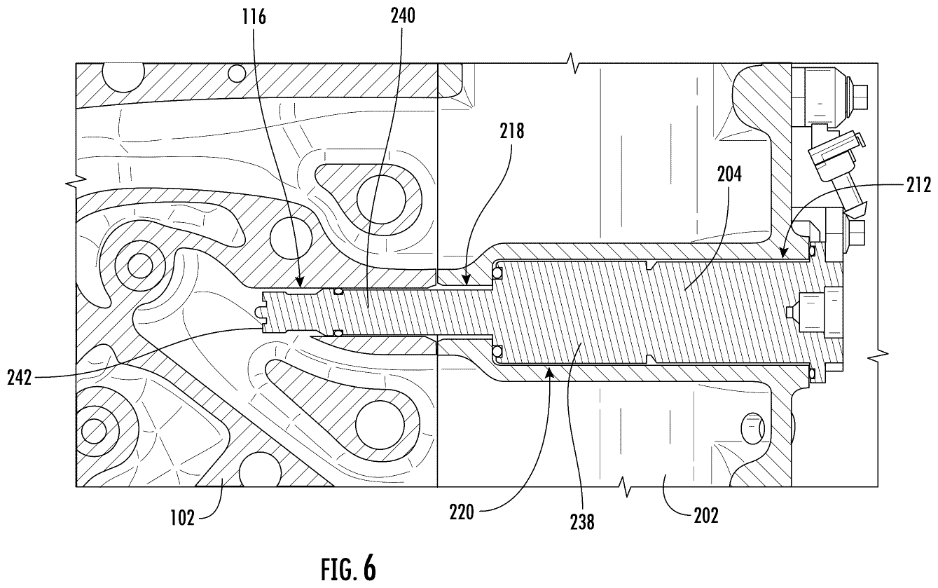

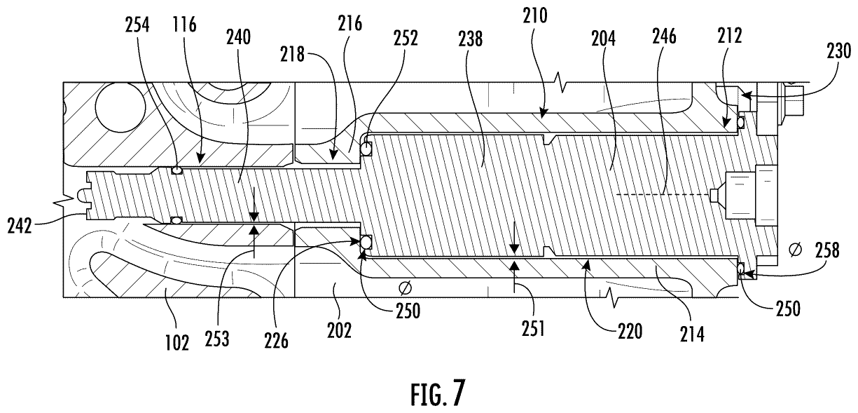

Referring to FIGS. 6-7, the second fuel injector 204 is configured to sealingly engage both the cylinder head 102 and the intake manifold 202. The tip portion 240 of the second fuel injector 204 extends through the first portion 218 of the bore 212 of the intake manifold 202 and into the injector bore 116 of the cylinder head 102. The injector body 238 is disposed at least partially within the second portion 220 of the bore 212.

Referring to FIG. 7, the intake manifold 202 (e.g., the bore 212) and the cylinder head 102 (e.g., the injector bore 116) are sized so that a first radial gap 251, and a combined radial width of a first annular space, between the second fuel injector 204 and the intake manifold 202 is greater than a second radial gap 253, and a combined radial width of a second annular space, between the second fuel injector 204 and the cylinder head 102. Such an arrangement can allow the second fuel injector 204 to float radially within the bore 212 and can accommodate a wider range of dimensional tolerance variation between the cylinder head 102 and the intake manifold 202, without significantly affecting the orientation of the tip portion 240 and nozzle 242 of the second fuel injector 204 within the cylinder head 102.

Referring to FIG. 7, the second fuel injector 204 further includes a first seal member 250, a second seal member 252, and a third seal member 254. The first seal member 250 is disposed axially between the second fuel injector 204 (e.g., the injector body 238) and the intake manifold 202. The first seal member 250 is disposed axially between an outer flange of the injector body 238 and the second axially facing sealing surface 230 of the injector mount 210 (e.g., the tube 214). The first seal member 250 is an axial sealing member that is configured to sealingly engage the second axially facing sealing surface 230 along an axial direction relative to the central axis 246 of the second fuel injector 204.

The second seal member 252 is disposed axially between the second fuel injector 204 and the intake manifold 202. The second seal member 252 is disposed axially between (i) an end (e.g., a nozzle end, a discharge end, etc.) of the injector body 238 nearest the tip portion of the second fuel injector 204, and (ii) the first axially facing sealing surface 226 (e.g., the step 216) of the injector mount 210 (e.g., the tube 214). The second seal member 252 is an axial sealing member that is configured to sealingly engage the first axially facing sealing surface 226 along an axial direction relative to the central axis 246 of the second fuel injector 204.

In the embodiment of FIG. 7, a second cord diameter 256 of the second seal member 252 is greater than a first cord diameter 258 of the first seal member 250. As used herein, cord diameter refers to an outer diameter of the seal member material (e.g., a cross-sectional diameter of the seal member itself). Such an arrangement can enable a larger range of axial positions of the second fuel injector 204 and/or angles of the second fuel injector 204 relative to the intake manifold 202. Such an arrangement can also accommodate a larger range of dimensional variation in the retrofit system 200 (e.g., to maintain sufficient crush of the seal member at extremes of dimensional tolerances between the second fuel injector 204, the cylinder head 102, and the intake manifold 202, to maintain accurate fuel spray plume targeting, without over-constraining the second fuel injector 204).

The first seal member 250 and the second seal member 252 provide a seal between the injector body 238 and the intake manifold 202, which can prevent ingress of debris into the gap (e.g., void, etc.) between the injector body 238 and the intake manifold 202.

The third seal member 254 is disposed radially between the second fuel injector 204 and the cylinder head 102 when the second fuel injector 204 is fully inserted into the intake manifold 202. The third seal member 254 is a radial sealing member that is configured to sealingly engage an inner sidewall of the injector bore 116 along a radial direction relative to a central axis 246 of the second fuel injector 204. The third seal member 254 is configured to prevent leakage of charge air and the second fuel 110 to a region between the cylinder head 102 and the intake manifold 202.

In the embodiment of FIGS. 6-7, the first seal member 250, the second seal member 252, and the third seal member 254 are O-ring seals that are disposed in corresponding grooves and/or slots formed into the second fuel injector 204 (e.g., the injector body 238, the tip portion 240, etc.). In other embodiments, the first seal member 250, the second seal member 252, and the third seal member 254 can be gaskets, or sealant material that is deposited into corresponding grooves/slots in the second fuel injector 204.

Referring again to FIG. 1, the dual fuel engine system 100 (e.g., the retrofit system 200) also includes a rotational support element 260 that is configured to secure the second fuel injector 204 in a single rotational position relative to the cylinder head 102. In the embodiment of FIG. 1, the rotational support element 260 is a fuel injector clamp 262 that is engaged with the second fuel injector 204 external to the intake manifold 202. The fuel injector clamp 262 is coupled (e.g., by a bolt or another type of mechanical fastener) to the manifold body 208. In other embodiments, the rotational support element 260 can be located in another location along the retrofit system 200 (e.g., another region of the intake manifold 202, etc.). The second fuel injector 204 constrains the second fuel injector 204 in a single rotational position with respect to the intake manifold 202 and the cylinder head 102.

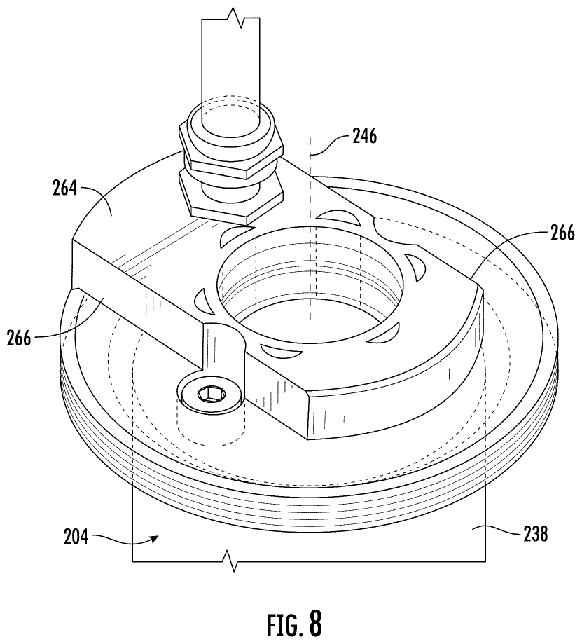

Referring to FIG. 8, the second fuel injector 204 includes a fuel injector mounting flange 264 at a proximal end of the second fuel injector 204 (e.g., the injector body 238). The fuel injector mounting flange 264 is coupled to the injector body 238 (e.g., a sealing flange at the proximal end of the injector body 238) by bolts or another type of mechanical fastener. In other embodiments, the fuel injector mounting flange 264 can be welded to the injector body 238 or integrally formed with the injector body 238 from a single piece of material.

In the embodiment of FIG. 8, the fuel injector mounting flange 264 is an elongated body that has only a single axis of symmetry that passes through the central axis 246 of the second fuel injector 204. In the embodiment of FIG. 8, the elongated body defines a first pair of parallel side surfaces 266 spaced radially apart from one another. In other embodiments, the shape of the fuel injector mounting flange 264 can be different. For example, the fuel injector mounting flange 264 can be shaped as an offset circle when viewed normal to the central axis 246, an offset oval shape, or another shape that has no axis of symmetry or that can otherwise constrain the rotational position of the second fuel injector 204.

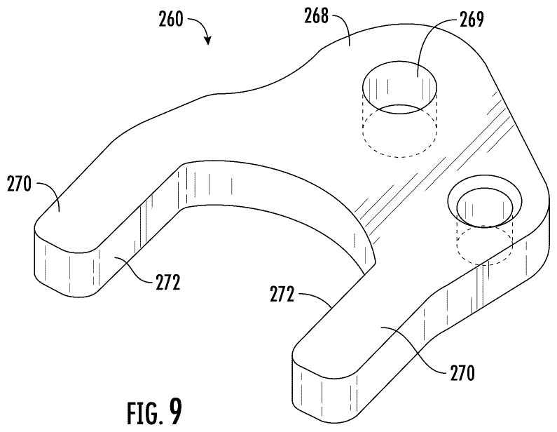

Referring to FIG. 9, the rotational support element 260 includes a support base 268 and a pair of extensions 270 (e.g., forks, prongs, blades, etc.) that are configured to receive the fuel injector mounting flange 264 therein. The support base 268 defines at least one opening 269 that is configured to facilitate coupling of the rotational support element 260 to the intake manifold 202 (see FIG. 1). The pair of extensions 270 define a second pair of parallel side surfaces 272 that are configured to engage with the first pair of parallel side surfaces 266 to secure the rotational position of the second fuel injector 204 within the intake manifold 202.

The orientation of the side surfaces can be different in various embodiments (e.g., arranged at different angles, etc.). The design of the rotational support element 260 (e.g., having forks, prongs, blades, etc.) provides a visual indicator that can facilitate assembly and rotational alignment of the second fuel injector 204.

In some embodiments, a lower surface of at least a portion of the rotational support element 260 (e.g., the forks, etc.) is configured to engage an upper surface of the fuel injector mounting flange 264 to hold the fuel injector mounting flange 264 against a machined face of the intake manifold 202.

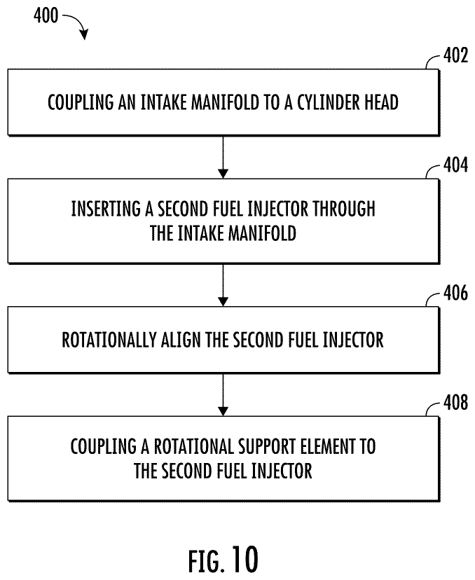

Referring to FIG. 10, a method 400 of making an engine system (e.g., a dual fuel engine system, etc.) and/or retrofitting a single-fuel engine system (e.g., compression ignition engine system, etc.) to utilize multiple fuels is shown, according to an embodiment. The method 400 can be used to manufacture the dual fuel engine system 100 and/or the retrofit system 200 of FIGS. 1-9. In other embodiments, the method 400 can include additional, fewer, and/or different operations.

The method 400 includes coupling an intake manifold to a cylinder head of the dual fuel engine system that can include a first fuel injector extending into the cylinder head. In other embodiments, the method 400 includes coupling the intake manifold to a cylinder head of a different type of engine system, including any of the engine system types described above. The first fuel injector is configured to dispense a first fuel. The method also includes inserting a second fuel injector through the intake manifold and into the cylinder head so that the second fuel injector is oriented to spray a second fuel that is the same as or different from the first fuel into an intake port that is defined by the cylinder head.

At operation 402, an intake manifold is coupled to a cylinder head. In some embodiments, operation 402 includes machining a cylinder head of a single-fuel compression ignition engine system to define an injector bore that extends into an intake port of the cylinder head. In other embodiments, operation 402 includes providing a replacement cylinder head that includes at least one injector bore for supporting a second fuel injector therein. In such instances, operation 402 can include removing an existing cylinder head from the engine system and coupling the replacement cylinder head to the engine block. Operation 402 can also include forming the intake manifold including the features described herein with respect to the intake manifold 202 or the intake manifold 302 of FIGS. 4 and 5, respectively. For example, operation 402 can include casting or otherwise forming at least one injector mount (e.g., at least one injector support tube) into a manifold body. Operation 402 can further include coupling the intake manifold to the cylinder head using bolts or another type of mechanical fastener.

At operation 404, a second fuel injector is inserted through the intake manifold and into the cylinder head so that the second fuel injector is oriented to spray a second fuel that is the same or different from the first fuel into an intake port that is defined by the cylinder head. In some embodiments, operation 404 includes aligning a central axis of the second fuel injector with a central axis of the injector mount on the intake manifold and pushing the second fuel injector into the injector mount.

In some embodiments, operation 404 further includes sealingly engaging the second fuel injector to the cylinder head and the intake manifold. For example, operation 404 can include sealingly engaging a first seal member axially between the second fuel injector and the intake manifold. Operation 404 can further include engaging a second seal member having a greater cord diameter than the first seal member axially between the second fuel injector and the intake manifold. In some embodiments, operation 404 also includes sealingly engaging a third seal member radially between the second fuel injector and the cylinder head to prevent leakage of charge air and/or the second fuel from the cylinder head.

At operation 406, the second fuel injector is rotationally aligned relative to the intake manifold and the cylinder head. In some embodiments, operation 406 includes rotating the second fuel injector so that the nozzle of the second fuel injector is oriented to spray fuel toward an intake opening of the intake port of the cylinder head and/or a rear surface of a valve head of an intake valve. Operation 406 can include rotating the second fuel injector within the injector mount, before inserting the second fuel injector, and/or during insertion of the second fuel injector into the injector mount. In some embodiments, operation 406 includes rotationally aligning a fuel injector mounting flange with a rotational alignment indicator on the manifold body and/or with a rotational support element that is coupled to the manifold body.

At operation 408, a rotational support element is coupled to the second fuel injector. In some embodiments, operation 408 includes engaging a pair of extension elements (e.g., forks) of the rotational support element with opposing sides (e.g., a pair of substantially parallel side surfaces) of a fuel injector mounting flange of the second fuel injector. In such embodiments, operation 408 can include slidably engaging the extension elements with the injector mounting flange to prevent relative rotation between the two. Operation 408 can further include coupling the rotational support element to the intake manifold by inserting fasteners through the rotational support element and into the manifold body.

Notwithstanding the embodiments described above in reference to FIGS. 1-10, various modifications and inclusions to those embodiments are contemplated and considered within the scope of the present disclosure.

The present technology can also include, but is not limited to, the features and combinations of features recited in the following lettered paragraphs, it being understood that the following paragraphs should not be interpreted as limiting the scope of the claims as appended hereto or mandating that all such features must necessarily be included in such claims:
A. A dual fuel engine system, comprising:
   a cylinder head defining an intake port;
   an intake manifold coupled to the cylinder head;
   a first fuel injector extending into the cylinder head and configured to dispense a first fuel; and
   a second fuel injector extending through the intake manifold and into the cylinder head, the second fuel injector configured to dispense a second fuel, the second fuel injector oriented to spray the second fuel into the intake port.
B. The dual fuel engine system of paragraph A, further comprising an intake valve disposed at least partially within the cylinder head, the intake valve including a valve head defining a rear surface facing toward the intake port, wherein the second fuel injector is oriented to spray the second fuel toward the rear surface.
C. The dual fuel engine system of paragraph B, wherein the second fuel injector is oriented substantially normal to a valve stem of the intake valve.
D. The dual fuel engine system of any one of the proceeding paragraphs, wherein the cylinder head defines an intake opening at an end of the intake port, further comprising an intake valve having a valve head that is configured to engage the cylinder head at the intake opening, wherein the second fuel injector is oriented to spray the second fuel toward the intake opening.
E. The dual fuel engine system of any one of the proceeding paragraphs, wherein the second fuel injector is an offset fuel injector that is configured to dispense the second fuel toward only a single side of the second fuel injector.
F. The dual fuel engine system of any one of the proceeding paragraphs, further comprising a rotational support element that is configured to secure the second fuel injector in a single rotational position relative to the cylinder head.
G. The dual fuel engine system of paragraph F, wherein the rotational support element is a fuel injector clamp that is engaged with the second fuel injector external to the intake manifold.
H. The dual fuel engine system of any one of the proceeding paragraphs, wherein the second fuel injector is configured to produce an asymmetric spray pattern of the second fuel.
I. The dual fuel engine system of any one of the proceeding paragraphs, further comprising a fuel rail assembly coupled to the intake manifold and fluidly coupled to the second fuel injector.
J. The dual fuel engine system of any one of the proceeding paragraphs, wherein the intake manifold includes an injector mount extending therethrough, the injector mount separating an airflow plenum of the intake manifold from the second fuel injector.
K. The dual fuel engine system of any one of the proceeding paragraphs, wherein the second fuel is different from the first fuel.
L. The dual fuel engine system of any one of the proceeding paragraphs, further comprising an engine block defining a cylinder, wherein the first fuel injector extends into the cylinder.
M. The dual fuel engine system of any one of the proceeding paragraphs, further comprising:
   a first seal member disposed axially between the second fuel injector and the intake manifold; and
   a second seal member disposed axially between the second fuel injector and the intake manifold, wherein a second cord diameter of the second seal member is greater than a first cord diameter of the first seal member.
N. an Intake Manifold, Comprising:
   a manifold body defining an airflow plenum therethrough; and
   an injector mount extending at least partially through the airflow plenum, the injector mount defining a bore extending through opposing ends of the manifold body, the bore sized to receive a fuel injector therein, the injector mount including a tube that fluidly separates the bore from an airflow plenum along an entire axial length of the bore.
O. The intake manifold of paragraph N, wherein the injector mount is integrally formed with the intake manifold as a unitary body from a single piece of material.
P. The intake manifold of paragraph N or O, wherein the injector mount includes a step separating a first portion of the bore from a second portion of the bore, the first portion having a reduced diameter relative to the second portion.
Q. The intake manifold of paragraph P, wherein the step defines a first axially facing sealing surface of the injector mount, the injector mount further defines a second axially facing sealing surface disposed along a perimeter of bore and spaced axially apart from the first axially facing sealing surface.
R. The intake manifold of paragraph P, wherein the first portion of the bore extends through a first end of the manifold body, and wherein the second portion of the bore extends through a second end of the manifold body opposite the first end.
S. The intake manifold of any one of paragraphs N to R, wherein the manifold body further defines a rail assembly mount for supporting a fuel rail assembly on the manifold body.
T. A method of manufacturing a dual fuel engine system, the method comprising:
   coupling an intake manifold to a cylinder head of the dual fuel engine system, the dual fuel engine system including a first fuel injector extending into the cylinder head and configured to dispense a first fuel; and
   inserting a second fuel injector through the intake manifold and into the cylinder head so that the second fuel injector is oriented to spray a second fuel into an intake port that is defined by the cylinder head.
U. The method of paragraph T, further comprising orienting the second fuel injector so that the second fuel injector dispenses the second fuel toward a rear surface of a valve head of an intake valve of the dual fuel engine system.
V. The method of paragraph T or U, further comprising rotationally aligning the second fuel injector with a fuel injector support element.
W. The method of paragraph V, further comprising coupling a rotational support element to the intake manifold and to the second fuel injector to secure a rotational position of the second fuel injector relative to the cylinder head.
X. The method of paragraph W, wherein coupling the rotational support element to the second fuel injector comprises:
   engaging forks of the rotational support element with opposing sides of a fuel injector mounting flange of the second fuel injector; and
   coupling the rotational support element to the intake manifold.
Y. The method of any one of paragraphs T to W, wherein inserting the second fuel injector comprises:
   engaging a first seal member axially between the second fuel injector and the intake manifold; and
   engaging a second seal member having a greater cord diameter than the first seal member axially between the second fuel injector and the intake manifold.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that can result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (e.g., permanent or fixed) or moveable (e.g., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References herein to the positions of elements (e.g., “top,” “bottom,” “above,” “below”) are merely used to describe the orientation of various elements in the FIGURES. It should be noted that the orientation of various elements can differ according to other exemplary embodiments, and that such variations are intended to be encompassed by the present disclosure.

Although the figures and description can illustrate a specific order of method steps, the order of such steps can differ from what is depicted and described, unless specified differently above. Also, two or more steps can be performed concurrently or with partial concurrence, unless specified differently above.

It is important to note that any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A dual fuel engine system, comprising:
a cylinder head defining an intake port;
an intake manifold coupled to the cylinder head;
a first fuel injector extending into the cylinder head and configured to dispense a first fuel; and
a second fuel injector extending through the intake manifold and into the cylinder head, the second fuel injector configured to dispense a second fuel, the second fuel injector oriented to spray the second fuel into the intake port.

2. The dual fuel engine system of claim 1, further comprising an intake valve disposed at least partially within the cylinder head, the intake valve including a valve head defining a rear surface facing toward the intake port, wherein the second fuel injector is oriented to spray the second fuel toward the rear surface.

3. The dual fuel engine system of claim 2, wherein the second fuel injector is oriented substantially normal to a valve stem of the intake valve.

4. The dual fuel engine system of claim 1, wherein the cylinder head defines an intake opening at an end of the intake port, further comprising an intake valve having a valve head that is configured to engage the cylinder head at the intake opening, wherein the second fuel injector is oriented to spray the second fuel toward the intake opening.

5. The dual fuel engine system of claim 1, wherein the second fuel injector is an offset fuel injector that is configured to dispense the second fuel toward only a single side of the second fuel injector.

6. The dual fuel engine system of claim 1, further comprising a rotational support element that is configured to secure the second fuel injector in a single rotational position relative to the cylinder head.

7. The dual fuel engine system of claim 6, wherein the rotational support element is a fuel injector clamp that is engaged with the second fuel injector external to the intake manifold.

8. The dual fuel engine system of claim 1, wherein the second fuel injector is configured to produce an asymmetric spray pattern of the second fuel.

9. The dual fuel engine system of claim 1, further comprising a fuel rail assembly coupled to the intake manifold and fluidly coupled to the second fuel injector.

10. The dual fuel engine system of claim 1, wherein the intake manifold includes an injector mount extending therethrough, the injector mount separating an airflow plenum of the intake manifold from the second fuel injector.

11. The dual fuel engine system of claim 1, wherein the second fuel is different from the first fuel.

12. The dual fuel engine system of claim 1, further comprising an engine block defining a cylinder, wherein the first fuel injector extends into the cylinder.

13. The dual fuel engine system of claim 1, further comprising:
a first seal member disposed axially between the second fuel injector and the intake manifold; and
a second seal member disposed axially between the second fuel injector and the intake manifold, wherein a second cord diameter of the second seal member is greater than a first cord diameter of the first seal member.

14. An intake manifold, comprising:
a manifold body defining an airflow plenum therethrough; and
an injector mount extending at least partially through the airflow plenum, the injector mount defining a bore extending through opposing ends of the manifold body, the bore sized to receive a fuel injector therein, the injector mount including a tube that fluidly separates the bore from the airflow plenum along an entire axial length of the bore.

15. The intake manifold of claim 14, wherein the injector mount is integrally formed with the intake manifold as a unitary body from a single piece of material.

16. The intake manifold of claim 14, wherein the injector mount includes a step separating a first portion of the bore from a second portion of the bore, the first portion having a reduced diameter relative to the second portion.

17. The intake manifold of claim 16, wherein the step defines a first axially facing sealing surface of the injector mount, the injector mount further defines a second axially facing sealing surface disposed along a perimeter of bore and spaced axially apart from the first axially facing sealing surface.

18. The intake manifold of claim 16, wherein the first portion of the bore extends through a first end of the manifold body, and wherein the second portion of the bore extends through a second end of the manifold body opposite the first end.

19. The intake manifold of claim 14, wherein the manifold body further defines a rail assembly mount for supporting a fuel rail assembly on the manifold body.

20. A method of manufacturing a dual fuel engine system, the method comprising:
coupling an intake manifold to a cylinder head of the dual fuel engine system, the dual fuel engine system including a first fuel injector extending into the cylinder head and configured to dispense a first fuel; and
inserting a second fuel injector through the intake manifold and into the cylinder head so that the second fuel injector is oriented to spray a second fuel into an intake port that is defined by the cylinder head.
